(19) United States
(12) Patent Application Publication
(10) Pub. No.: US 2010/0060757 A1
(43) Pub. Date: Mar. 11, 2010

(54) SOLID-STATE IMAGE PICKUP DEVICE

(75) Inventors: Kosuke Takasaki, Kurokawa-Gun (JP); Mamoru Iesaka, Atsugi-shi (JP); Hideki Wako, Toyohashi-shi (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/518,556

(22) PCT Filed: Dec. 10, 2007
(86) PCT No.: PCT/JP2007/074179

§ 371 Date: Oct. 14, 2009

(30) Foreign Application Priority Data
Dec. 11, 2006 (JP) 2006-333584

(51) Int. Cl. H04N 5/335

(52) U.S. Cl. 348/294; 348/E05.091

(57) ABSTRACT

A solid-state image pickup device (1) comprises: an image sensor wafer (2A) including image sensors (3); an optically-transparent protection member (4) connected by use of an adhesive agent (7) via a spacer (5) arranged to surround the image sensors (3); and an electrostatic (ESD) protection circuit (10) disposed on the image sensor wafer (2A) so as to avoid a position corresponding to a connected surface where the spacer (5) and the image sensor wafer (2A) are connected. Accordingly, in this configuration, even when polarization occurs in the adhesive agent, since the p-well layer between diffusion layers of the ESD protection circuit is not disposed immediately below the connected surface, the p-well layer is not inverted by electric charges in the element interface and thus parasitic MOS transistor does not turn on, allowing suppression of leak current.

### TECHNICAL FIELD

The present invention relates to a solid-state image pickup device in which a wafer having formed therein a solid-state image sensor and an optically-transparent protection member are connected via a spacer arranged to surround the solid-state image sensor.

### BACKGROUND ART

In recent years, there have been requests for further miniaturization of solid-state image pickup devices composed of CCD (Charge Coupled Device) or CMOS (Complementary Metal Oxide Semiconductor), used in a digital camera or mobile telephone.

Based on such requests, in order to achieve miniaturization of solid-state image pickup devices, there have been proposed solid-state image pickup devices and manufacturing methods thereof, the solid-state image pickup devices being manufactured by connecting a solid-state image sensor wafer having formed therein many light-receiving parts of solid-state image sensors and an optically-transparent protection member via a spacer formed in a manner corresponding to a position which surrounds each light-receiving part, and thereafter separating the resulting substrate into individual. solid-state image pickup devices (for example, Japanese Patent Laid-Open No. 2001-351997).

An example of the above described solid-state image pickup device will be described. FIGS. 1 and 2 are a perspective view illustrating an external configuration of the solid-state image pickup device and a cross-sectional view thereof, respectively. The solid-state image pickup device 1 is constituted of: a solid-state image sensor chip 2 manufactured by cutting a solid-state image sensor wafer having arranged therein solid-state image sensors 3; a frame-shaped spacer 5 which surrounds the solid-state image sensors 3 mounted in the solid-state image sensor chip 2; and an optically-transparent member 4 which is mounted on the spacer 5 to seal the solid-state image sensors 3.

The solid-state image sensor chip 2 is, as illustrated in FIG. 2, constituted of: a rectangular shaped chip substrate 2A; a solid-state image sensors 3 formed on the chip substrate 2A; and a plurality of the pads (electrodes) 6 for wiring to the outside, which are arranged around the solid-state image sensors 3. The material of the chip substrate 2A is, for example, silicon monocrystal, and its thickness is about 300 μm, for example.

Used for the optically-transparent member 4 is an optically-transparent material such as transparent glass, resin and so on, for example, “PYREX (registered trademark) glass”. Its thickness is about 500 μm, for example.

For the spacer 5, a material having properties, such as thermal expansion coefficient, similar to those of the chip substrate 2A and the transparent plate 4 is preferably used, and thus multicrystal silicon or the like is used, for example. A part of the frame-shaped spacer 5 has a cross-section about 200 μm in width and about 100 μm in thickness, for example. One end face 5A of the spacer 5 is connected by use of an adhesive agent 7 to the chip substrate 2A, and the other end face is connected by use of an adhesive agent 8 to the transparent plate 4.

In the above described solid-state image pickup device 1, between the pads 6 and an internal circuit including the solid-state image sensors 3, there are arranged electrostastic discharge protection circuits (hereinafter referred to as an ESD protection circuits) illustrated in FIG. 3 that protect the internal circuit from electrostastic discharge which occurs in the pads 6.

FIG. 4 is a cross-sectional view illustrating the ESD protection circuit section of the solid-state image pickup device. In the ESD protection circuit 10, n-type semiconductors acting as diffusion layer sections are formed in a separated manner on the surface of a semiconductor substrate having a p-type well layer 11 formed on a n-type substrate; one diffusion layer 13 is connected to a wire 15 which connects to the internal circuit and pad 6, and the other diffusion layer 12 is connected to a ground wire 16 having a voltage lower than a voltage applied to the internal circuit.

An insulating film 14 of SiO₂ is formed on the surface of the p-type well layer 11 between the diffusion layers 12 and 13. Further formed thereon are a BPSG film 19 being an interlayer insulating film, an SiN film 17 constituting an intralayer lens and the like, and a CCD surface layer resin 18.

Since the ESD protection circuits 10 are, as illustrated in FIG. 5, typically disposed below the spacer 5, a connected surface 7A where the spacer 5 and the chip substrate 2A are connected by use of the adhesive agent 7 is disposed above the ESD protection circuits 10.

When the solid-state image pickup device 1 is used for a long period of time, the whole solid-state image pickup device 1 may generate heat, causing the resin material of the adhesive agent 7 and the like to have a high temperature. In the adhesive agent 7 having a high temperature, molecule cross-linking becomes loose, and polarization is more likely to occur due to mobile ion movement and to orientation of molecule and electron in polymer molecule in the adhesive agent 7.

When polarization occurs in the adhesive agent 7, an electric field 23 is, as illustrated in FIG. 6, produced by electric charges 22 in the interface between the adhesive agent 7 and the image sensors 3, and since the p-type well layer 11 between the diffusion layers 12 and 13 of each of the ESD protection circuits 10 is low in impurity concentration, the p-type well layer 11 inverts to turn on a parasitic MOS transistor, and thus leak current 24 flows into the ground wire.

The leak current 24 generated in the ESD protection circuit 10 causes occurrence of noises or operational trouble in the solid-state image pickup device 1, leading to degradation of the ESD protection circuit 10 and solid-state image sensor 3.

The present invention has been achieved to address the above problem, and has an object to provide a solid-state image device in which the production of parasitic MOS transistor is prevented so that leak current is not generated in the ESD protection circuit section of the solid-state image device, and a manufacturing method for the solid-state image device.

Referring to FIG. 5, the ESD protection circuits 10, wires for connecting the pads 6 and the internal circuit and the like are formed on the chip substrate 2A for the convenience of explanation; but they may be formed in the inside of the chip substrate 2A.

### DISCLOSURE OF THE INVENTION

To achieve the above object, according to a first aspect of the present invention, a solid-state image pickup device comprises: an image sensor wafer on which image sensors are formed; a spacer arranged to surround the image sensors; an optically-transparent protection member connected to the image sensor wafer by use of an adhesive agent via the spacer; and an electrostatic protection circuit being disposed on the image sensor wafer so as to avoid a position corresponding to a connected surface where the spacer and the image sensor wafer are connected.

According to the first aspect, the ESD protection circuit formed in the image sensor wafer is disposed not immediately below the position corresponding to the connected surface where the spacer and the image sensor wafer are connected by use of the adhesive agent.

Accordingly, even when polarization occurs in the adhesive agent, since the p-well layer between the diffusion layers of the ESD protection circuit is not disposed immediately below the connected surface, the p-well layer is not inverted by electric charges in the element interface and thus the parasitic MOS transistor does not turn on, allowing suppression of leak current.

According to a second aspect of the present invention, in the solid-state image pickup device of the first aspect, the distance between the electrostastic protection circuit and an internal circuit of the solid-state image pickup device is larger than a width of the connected surface where the spacer and the image sensor wafer are connected.

According to the second aspect, the connecting location of the ESD protection circuit connected to wire between the internal circuit and a pad for connecting the internal circuit to an external circuit is closer to the pad. Since the distance between the connecting location and the internal circuit is larger than the width of the connected surface where the spacer and the image sensor wafer are connected by use of an adhesive agent, the ESD protection circuit is not disposed immediately below the connected surface.

Accordingly, even when polarization occurs in the adhesive agent, the p-well layer does not invert and thus a parasitic MOS transistor does not turn on, allowing suppression of leak current.

According to a third aspect of the present invention, in the solid-state image pickup device of the first aspect, the electrostatic protection circuit is formed between a plurality of pads formed on the image sensor wafer, for connection between the internal circuit of the solid-state image pickup device and an external circuit.

According to the third aspect, the ESD protection circuit is formed between the plurality of pads formed on the surface of the image sensor wafer, for connection between the internal circuit and the external circuit. A structural object made of, for example, resin or metal are prevented from being placed and connected on the pads, in order to avoid from damaging the wire for connection to external wiring or from damaging sealing by interfusion of voids into the connection layer.

Accordingly, the connected surface is not formed above the ESD protection circuit; even when polarization occurs in the adhesive agent, the p-well layer does not invert and thus the parasitic MOS transistor does not turn on, allowing suppression of leak current.

As described above, according to the inventive solid-state image pickup device, even when polarization occurs in the adhesive agent, since the p-well layer between the diffusion layers of the ESD protection circuit is not disposed immediately below the connected surface, the p-well layer is not inverted by electric charges on the element interface and thus the production of parasitic MOS transistor is prevented, allowing prevention of generation of leak current in the ESD protection circuit of the solid-state image pickup device.

### BRIEF DESCRIPTION OF THE DRAWINGS

FIG. 1 is a perspective view illustrating an external configuration of a solid-state image pickup device;

FIG. 2 is a cross-sectional view illustrating the gist of the solid-state image pickup device;

FIG. 3 is a circuit diagram illustrating an exemplary configuration of electrostatic protection circuit;

FIG. 4 is a cross-sectional view illustrating a configuration of the electrostatic protection circuit;

FIG. 5 is a top view illustrating a conventional solid-state image pickup device;

FIG. 6 is a cross-sectional view illustrating the cause of leak current;

FIG. 7 is a top view illustrating a solid-state image pickup device according to a first embodiment of the present invention; and

FIG. 8 is a top view illustrating a solid-state image pickup device according to a second embodiment of the present invention.

### DESCRIPTION OF SYMBOLS

1 solid-state image pickup device
2 solid-state image sensor chip
2A chip substrate
3 solid-state image sensor
4 transparent plate
5 spacer
5A end face
6 pad
7 adhesive agent
7A connected surface
10 ESD protection circuit
11 p-well layer
12, 13 diffusion layer
14 insulating film
15 wire
16 ground wire
17, 17A SiN film
18 CCD surface resin
19 BPSG film
21 wire
22 charge
23 electric field
24 leak current

### BEST MODE FOR CARRYING OUT THE INVENTION

Preferred embodiments of a solid-state image pickup device and a manufacturing method thereof according to the present invention will be described in detail with reference to the accompanying drawings.

First, the configuration of the solid-state image pickup device and electrostatic protection circuit (ESD protection circuit) according to the present invention will be described.

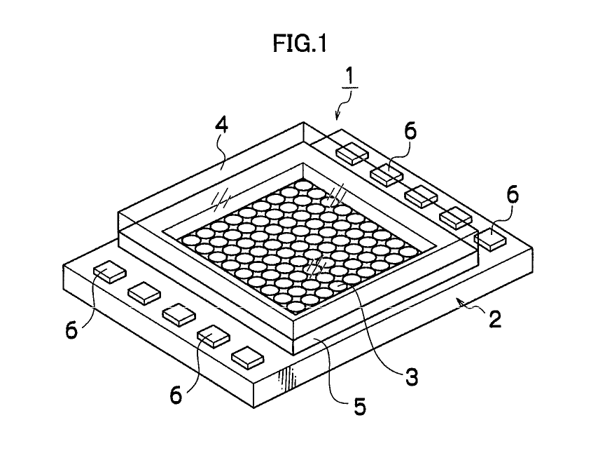

The solid-state image pickup device 1 illustrated in FIG. 1 comprises: a solid-state image sensor chip 2 having arranged therein solid-state image sensors 3; a frame-shaped spacer 5 mounted in the solid-state image sensor chip 2, and surrounding the solid-state image sensors 3; and an optically-transparent member 4 mounted on the spacer 5, for sealing the solid-state image sensors 3.

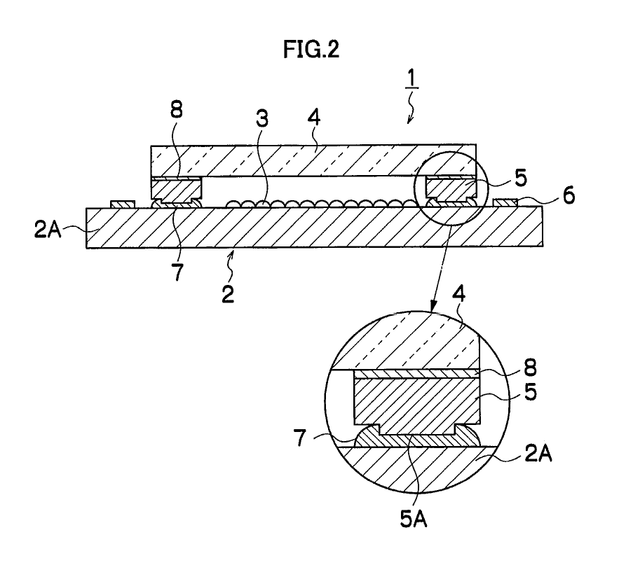

The solid-state image sensor chip 2 includes, as illustrated in FIG. 2, a rectangular-shaped chip substrate 2A, the solid-state image sensors 3 formed on the chip substrate 2A, and pads 6 for wiring to the outside. The material of the chip substrate 2A is, for example, silicon monocrystal, and its thickness is about 300 μm, for example.

Used for the optically-transparent member 4 is an optically-transparent material such as transparent glass, resin, and so on, for example, “PYREX (registered trademark) glass”. Its thickness is about 500 μm, for example.

For the spacer 5, a material having properties, such as thermal expansion coefficient, similar to those of the chip substrate 2A and the transparent plate 4 is preferably used, and thus multicrystal silicon or the like is used, for example. A part of the frame-shaped spacer 5 has a cross-section about 200 μm in width and about 100 μm in thickness, for example. One end face 5A of the spacer 5 is connected by use of an adhesive agent 7 to the chip substrate 2A, and the other end face is connected by use of an adhesive agent 8 to the transparent plate 4.

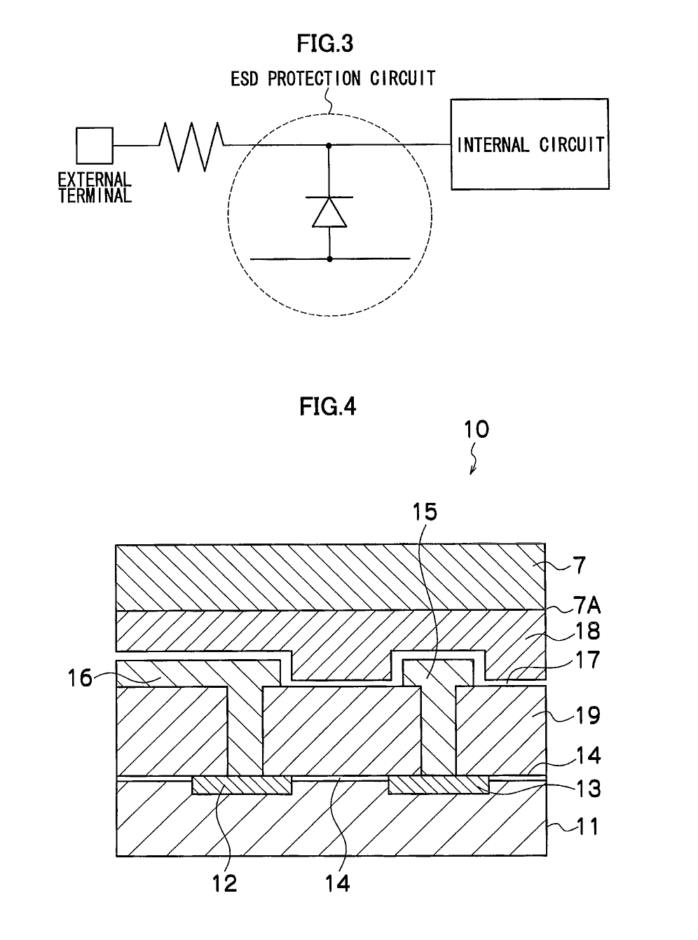

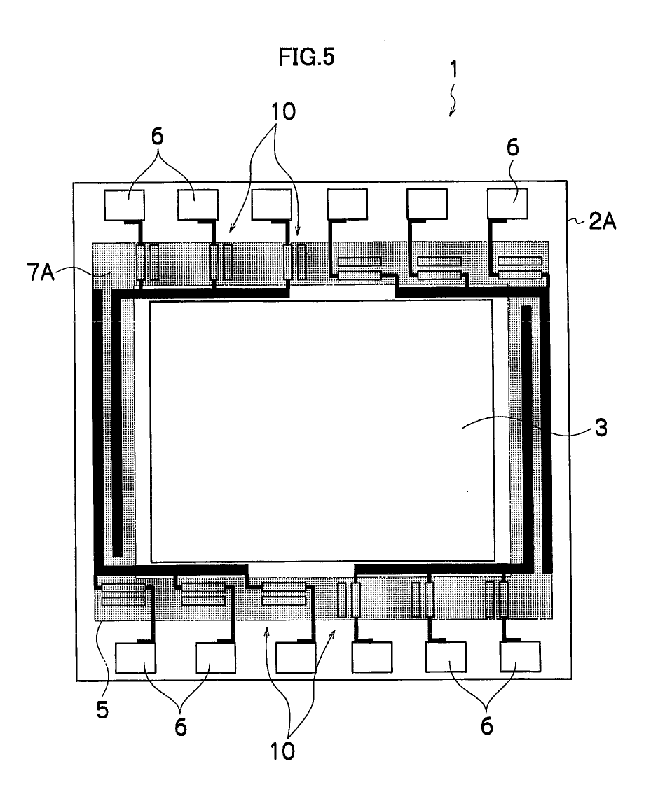

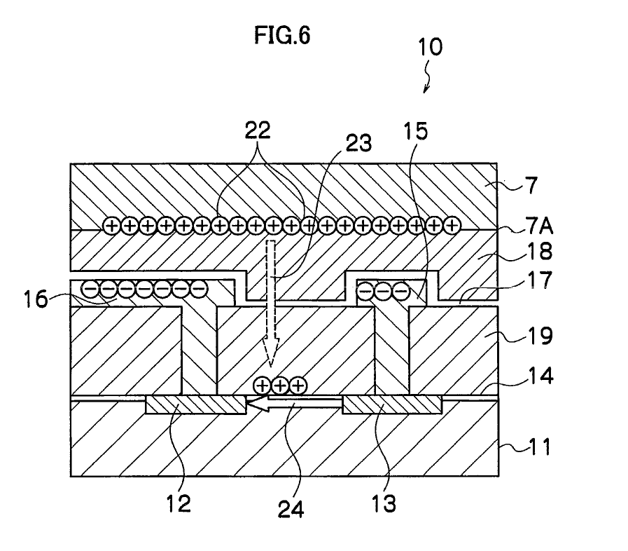

Between the pads 6 and an internal circuit including the solid-state image sensors 3 and the like, there are arranged ESD protection circuits illustrated in FIG. 3.

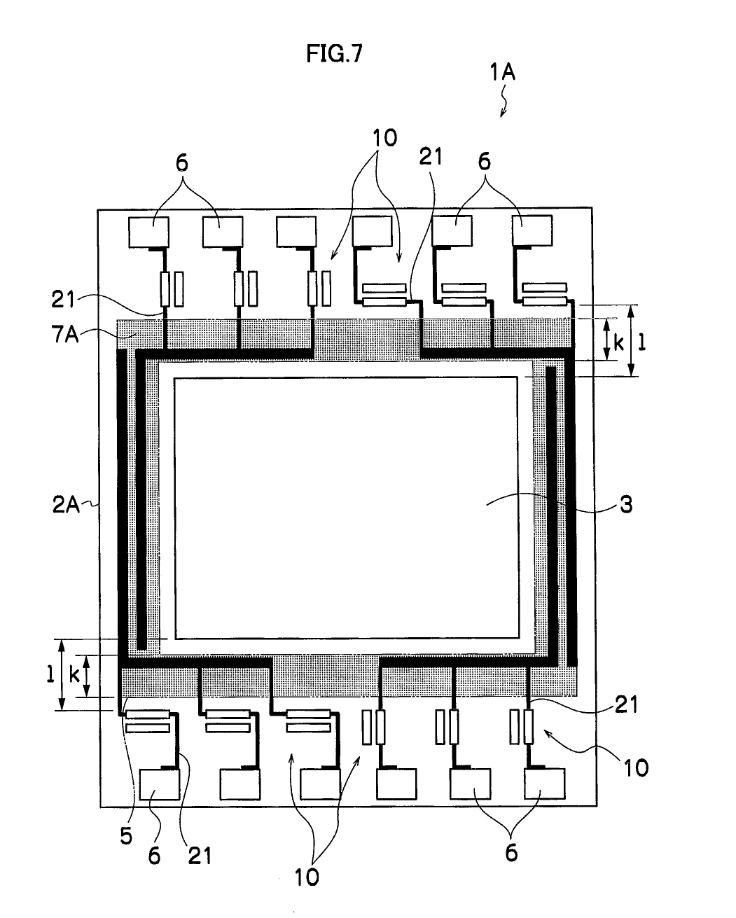

A first embodiment of the solid-state image pickup device according to the present invention will be described. FIG. 7 is a top view illustrating the solid-state image pickup device according to the first embodiment.

In the solid-state image pickup device 1A, as illustrated in FIG. 7, the spacer 5 illustrated in FIG. 1 is mounted so as to surround the solid-state image sensors 3 formed on the chip substrate 2A; the optically-transparent member 4 is mounted on the spacer 5, so that the solid-state image sensors 3 are sealed.

Further arranged on the chip substrate 2A are the pads 6 for wiring between the internal circuit containing the solid-state image sensors 3 and the outside; the pads 6 and the internal circuit are connected via wires 21. The ESD protection circuits 10 are arranged in the middle of the wires 21.

In this case, the ESD protection circuits 10 are formed so that distance 1 between the ESD protection circuit 10 and the internal circuit is larger than width k of the connected surface 7A where the spacer 5 and the chip substrate 2A are connected by use of the adhesive agent 7.

Accordingly, the ESD protection circuits 10 are prevented from being disposed immediately below the connected surface 7A. Thus, even when polarization occurs in the adhesive agent 7, since the p-well layer between the diffusion layers of each of the ESD protection circuit 10 is not disposed immediately below the connected surface 7A, each the p-well layer is not inverted by electric charges in the interface between each image sensor, and thus the parasitic MOS transistor does not turn on, allowing suppression of leak current.

Referring to FIG. 7, the ESD protection circuits 10, the wires 21 for connection between the pads 6 and the internal circuit, and the like are arranged on the chip substrate 2A for the convenience of explanation; but they may be formed in the inside of the chip substrate 2A.

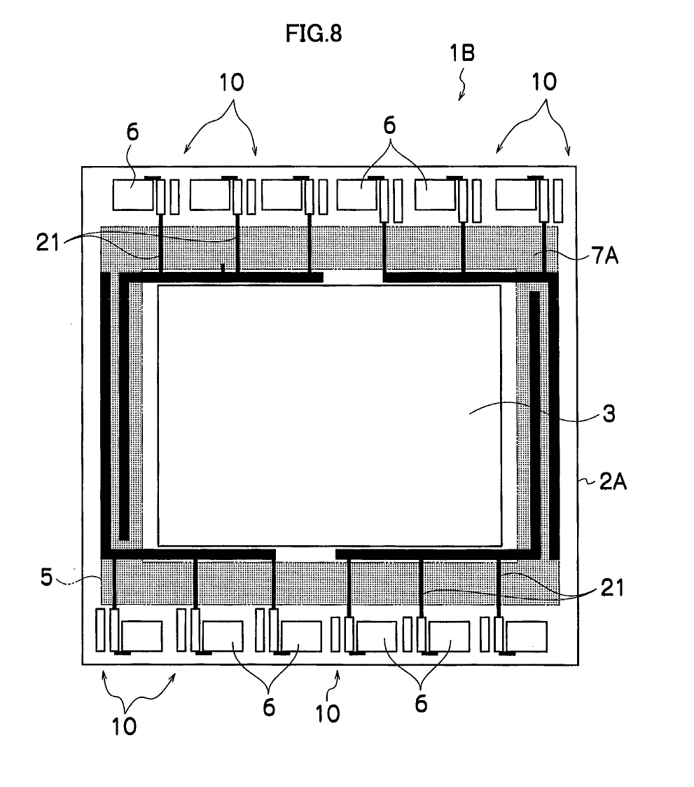

A second embodiment of the solid-state image pickup device according to the present invention will be described. FIG. 8 is a top view illustrating the solid-state image pickup device according to the second embodiment.

In the second embodiment, the same reference numerals are applied to parts identical to or similar to those of the first embodiment, and an explanation thereof is omitted.

In the solid-state image pickup device 1B, as illustrated in FIG. 8, the solid-state image sensors 3 are formed on the chip substrate 2A; the spacer 5 is mounted around the solid-state image sensors 3; the optically-transparent member 4 is mounted on the spacer 5.

Further arranged on the chip substrate 2A are the pads 6; the pads 6 and the internal circuit are connected via wires 21. Each of the ESD protection circuits 10 is arranged in the middle of each of the wires 21.

In this case, each of the ESD protection circuits 10 is formed between plural pads 6 formed on the chip substrate 2A. A structural object such as the spacer 5 is prevented from being connected on the pads, in order to avoid from damaging the wires for connection to external wirings or from damaging sealing by interfusion of voids into the connection layer. Thus, the spacer 5 is prevented from being arranged above the ESD protection circuits; and the ESD protection circuits 10 are prevented from being disposed immediately below the connected surface 7A.

Accordingly, even when polarization occurs in the adhesive agent 7, since the p-well layer between the diffusion layers of each of the ESD protection circuits 10 is not disposed immediately below the connected surface 7A, the p-well layer is not inverted by electric charges in the interface between each image sensor and thus the parasitic MOS transistor does not turn on, allowing suppression of leak current.

Also, each of the ESD protection circuits 10 has a higher effect of protecting the internal circuit as each of the ESD protection circuit 10 is disposed closer to the signal input part and farther from the internal circuit. Thus, the ESD protection circuits 10 formed according to the present embodiment are preferable in protecting the internal circuit.

Referring to FIG. 8, the ESD protection circuits 10, the wires 21 for connection between the pads 6 and the internal circuit, and the like are arranged on the chip substrate 2A for the convenience of explanation; but they may be formed in the inside of the chip substrate 2A.

### Examples

Specific examples of the solid-state image pickup device according to the present invention will be described.

First, with respect to leak current generation, the solid-state image pickup device manufactured according to the first embodiment is compared to a solid-state image pickup device not based on the present invention.

Leak current of about 10 to 60 μA was generated in the solid-state image pickup device 1 not based on the present invention illustrated in FIG. 5. In contrast, no leak current was generated in the solid-state image pickup device 1A of the present invention illustrated in FIG. 7, and thus the effects of the present invention were verified.

Next, with respect to leak current generation, the solid-state image pickup device 1B manufactured according to the second embodiment illustrated in FIG. 8 is compared to the solid-state image pickup device not based on the present invention. Leak current of about 10 to 60 μA was generated in the solid-state image pickup device 1 not based on the present invention illustrated in FIG. 5. In contrast, no leak current was generated in the solid-state image pickup device 1B of the present invention, and thus the effects of the present invention were verified.

As described above, according to the solid-state image pickup device of the present invention, since the p-well layer is prevented from inverting, the production of parasitic MOS transistor is prevented, allowing prevention of generation of leak current in the ESD protection circuit section of the solid-state image device.

1. A solid-state image pickup device comprising:
an image sensor wafer on which image sensors are formed;
a spacer arranged to surround the image sensors;
an optically-transparent protection member connected to the image sensor wafer by use of an adhesive agent via the spacer; and
an electrostatic protection circuit disposed on the image sensor wafer so as to avoid a position corresponding to a connected surface where the spacer and the image sensor wafer are connected.

2. The solid-state image pickup device according to claim 1, wherein
the distance between the electrostastic protection circuit and an internal circuit of the solid-state image pickup device is larger than a width of the connected surface where the spacer and the image sensor wafer are connected.

3. The solid-state image pickup device according to claim 1, wherein the electrostatic protection circuit is disposed between a plurality of pads formed on the image sensor wafer, for connection between the internal circuit of the solid-state image pickup device and an external circuit.
